(19) United States
(12) Patent Application Publication
(10) Pub. No.: US 2007/0080812 A1
(43) Pub. Date: Apr. 12, 2007

(54) Awareness enhancement and monitoring devices for the treatment of certain impulse control disorders

(76) Inventor: David Perlman, Ann Arbor, MI (US)

Correspondence Address: GIFFORD, KRASS, SPRINKLE,ANDERSON & CITKOWSKI, P.C, PO BOX 7021, TROY, MI, 48007-7021, US

(21) Appl. No.: 11/233,972

(22) Filed: Sep. 23, 2005

(51) Int. Cl. G08B 23/00

(52) U.S. Cl. 340/573.1

(57) ABSTRACT

Apparatus for monitoring and discouraging trichotillomania and other unwanted behaviors includes a proximity detector, an event logger, and a user input facilitating event characterization. The proximity detector includes a sensor and an element associated with the arm, hand, finger, head or other user body part. The proximity detector is operative to generate an output signal in the event that the element has physically moved to within a predetermined distance relative to the sensor. The apparatus further includes a device operative to alert the user in response to the output signal generated by the proximity detector. Additional circuitry is provided enabling events to be examined and reviewed. Such circuitry would include a memory for storing information associated with alert events and an interface allowing the events to be examined and reviewed on a personal computer, for example. The provision of a real-time clock further enables date or time information to be stored in conjunction with an event. For additional insight into the events, an input may be provided allowing a user to characterize an event at the time of occurrence.

### FIELD OF THE INVENTION

The present invention relates generally to apparatus for persons suffering from trichotillomania and other such disorders and, more particularly, to a biofeedback device and associated methods of use for monitoring the movement of one body part toward another and an input for receiving user characterization of the movement

### BACKGROUND OF THE INVENTION

The diagnostic and statistical manual mental disorders (DSM-IV, American Psychiatric Association, 1994) defines trichotillomania as recurrent pulling of one's hair resulting in noticeable hair loss accompanied by an increase in tension before pulling followed by pleasure, gratification, or relief when plucking out the hair. In order to meet diagnostic criteria, pulling must result in significant distress or functional impairment. Hair pulling in trichotillomania is episodic and usually begins with examining a pulling site for a suitable hair, handling and extracting the hair, followed by examining, touching, and/or consuming the hair (Gaffney, 1995). Common hair pulling sites include the scalp, eyelashes, eyebrows, or pubic regions (Christenson, Mackenzie, & Mitchell, 1992). Most persons with trichotillomania pull from more than one site (Christenson & Crow, 1996).

Hair pulling can occur at any time but individuals who pull from their scalp report an average of 27 to 30 pulling incidents per week where as eyelash pullers report approximately 15 to 17 episodes per week (Christenson, Mackenzie, and Mitchell, 1991). Trichotillomania is often time consuming. Approximately one-half of persons with trichotillomania pull hair for more than one hour a day (Mansueto, 1990) and some pull up to eight hours or more daily (Koran et al, 1992).

Hair pulling behavior usually occurs when individuals are alone engaging in sedentary activities such as reading, watching television, talking on the telephone, or resting in bed (Schlosser, Black, Blum, and Goldstein, 1994; Christenson, et al., 1991; Stanley and Mouton, 1996). Certain emotional states such as boredom, anger, tension, and feelings of indifference are also associated with increased hair pulling (Stanley, Borden, Mouton, Breckenridge, 1995).

Two subtypes of hair pulling have been observed among persons with trichotillomania, focused and automatic pulling (Christenson and Crow, 1996). Focused pulling involves purposeful hair pulling commonly performed in response to disturbing thoughts or increased anxiety. Persons engaged in focused pulling often report high levels of tension prior to pulling followed by a sense of relief after a pulling episode (Christenson and Mackenzie, 1994). The automatic subtype refers to pulling that occurs outside of the person's awareness (Christenson and Mackenzie, 1994, Mansueto, 1990). Automatic pulling often occurs in certain high risk sedentary situations such as lying in bed, watching television, reading, or talking on the telephone. Christenson and Mackenzie (1994) noted over 75 percent of patients with trichotillomania report the majority of their hair pulling happens automatically. Although automatic pulling occurs most frequently, most persons with trichotillomania experience both focused and automatic hair-pulling (Christenson, 1996).

Trichotillomania has a significant impact on quality of life including social, psychological, and physical hardships (du Toit, et al., 2001). Persons with trichotillomania often avoid haircuts, swimming, going out in windy conditions, participating in sports, engaging in sexual relations, and attending other public activities (du Toit, et al., 2001; Stein, et al., 1999). Approximately one-half of persons with trichotillomania report that their close relationships are harmed by repetitive pulling (Stemberger, Thomas, Mansueto, and Carter, 2000). Intimate relationships are often impacted by trichotillomania because of concerns about a partner discovering balding areas, especially in pubic areas (Stemberger, et al., 2000). Over three-quarters of persons with trichotillomania report that they keep secrets about the intensity of their hair pulling from their family and friends (Stemberger, et al., 2000). In addition to social and interpersonal hardships, persons with trichotillomania also often avoid doctors for fear their physical exam will reveal hair loss that would be difficult to explain (O'Sullivan, et al 1997).

In addition to these quality life impairments, persons with trichotillomania can experience physical problems related to their pulling. O'Sullivan, et al (1997), report that skin imperfections, scarring, and hair related trauma are often associated with trichotillomania. Repeated hair pulling can also contribute to the development of repetitive motion injuries such as carpel tunnel syndrome, musculoskeletal pain, and the development of calluses and cuts on one's fingers (O'Sullivan, Keuthan, and Gumley, 1996). Repetitive ingestion of hairs can also be associated with the development of trichobezoars which typically need to be removed surgically to avoid morbidity (DeBakey & Ochsner, 1939 *from Stein page 24).

Trichotillomania can also result in financial hardships. Persons with trichotillomania also report spending excessive amounts of money on wigs and other hair care products in order to help conceal the effects of pulling (Stanley and Mouton, 1996). Finally, patients with trichotillomania often suffer from overall reductions in reductions in self-esteem related to hair pulling (Soriano, O'Sullivan, Baer, L., Phillips, McNally, and Jenike, 1996).

Trichotillomania is commonly co-occurs with other psychiatric disorders. Christenson and associates (1991) reported that approximately 85% of their trichotillomania patients had a lifetime history of other habit disorders, such as skin picking, nail biting, and thumb sucking. Mood disorders (65%), anxiety disorders (57%), eating disorders (20%), and substance abuse conditions (22%) were also quite common among this sample of treatment seeking patients (Christenson, et al., 1991).

Substantial attention has been given to the association between Obsessive-Compulsive Disorder (OCD) and trichotillomania (Himle et al., 1995, need more here). The most obvious phenomenological similarity between OCD and trichotillomania is the repetitive nature of the problematic behaviors. In addition, there are similar neuropsychological deficits, somewhat similar familial history of psychiatric problems, and relatively comparable results from drug or psychological treatments (Swedo, 1993). Conversely, there are significant differences between OCD and trichotillomania including differing psychotherapeutic treatments (i.e. habit reversal versus exposure and response prevention), differences in mean age of onset, stressors associated with onset, reduced levels of general anxiety, and lower overall psychopathology among those with trichotillomania (Himle, et al., 1995). Another important phenomenological difference is that pleasure often observed in trichotillomania is almost never present in OCD (Stanley, Swann, Bowers, Davis, and Taylor, 1992). Patients with trichotillomania report fewer obsessive compulsive symptoms, experience less interference from these symptoms, and put up less resistance to these repetitive behaviors compared to persons with OCD (Stanley, et al. 1992).

Serotinin reuptake inhibiting medications are commonly used to treat trichotillomania. In multiple controlled trials, clomipramine (e.g.), fluoxetine (e.g.), sertraline (e.g.), fluvoxamine (e.g.) and paroxetine ( ) have been found to be superior to placebo. However, effect sizes in many of these studies are relatively modest (refs) and between *% and *% of patients did not experience clinically significant improvement in these trials. Talk about the opiate agonists here . . . . Beyond the modest benefits observed with the pharmacological treatment of trichotillomania, many patients refuse medication treatment making an efficacious psychosocial treatment especially needed.

The most widely tested and accepted psychosocial treatment for trichotillomania is habit reversal training. Azrin and colleagues (Azrin, Nunn, and Franz, 1973) first introduced habit reversal training. Habit reversal involves several strategies. Initial training in habit reversal involves a self-monitoring program where the frequency and duration of the hair pulling is recorded. A second major element of habit reversal training is to build motivation for the patient to participate in habit reversal training by conducting a motivational review of the inconveniences caused by the hair pulling behavior.

The third important step in habit reversal training is awareness training, which includes a thorough discussion of the specific movements associated with hair pulling, a review of specific behaviors and emotional responses which immediately precede and follow pulling behavior (response precursors), and situational triggers of hair pulling (habit-prone situations). Completing response training is a fourth major step in habit reversal therapy. This element involves identifying and rehearsing an alternative behavior that is incompatible with hair pulling.

Overall, habit reversal and other related behavioral interventions hold promise in the treatment of trichotillomania. However, approximately 30-40% of patients in most studies do not experience clinically significant improvement after acute treatment and available information suggests that maintenance of gains may be problematic. There is a need to innovate to improve both initial and long-term outcomes with habit reversal therapy. Improved methods of reliably assessing rates of trichotillomania and associated progress in treatment with a non-burdensome, real-time method would be of great value to both clinicians and researchers.

### SUMMARY OF THE INVENTION

This invention broadly provides apparatus for monitoring and discouraging trichotillomania, as well as certain other types of obsessive compulsive spectrum and habit disorders including onychophagia, thumb sucking, skin scratching, and other forms of self-inflicted harm. The preferred embodiment, called the Awareness Enhancement and Monitoring Device (AEMD), includes a proximity detector, an event logger, and a user input facilitating event characterization.

The proximity detector includes a sensor and an element associated with the arm, hand, finger, head or other user body part. The proximity detector is operative to generate an output signal in the event that the element has physically moved to within a predetermined distance relative to the sensor. The apparatus further includes a device operative to alert the user in response to the output signal generated by the proximity detector.

Either the sensor, the element to be detected, or both, may include electrically active or passive devices. For other disorders such as hair pulling and scratching, the sensor may be located wherever the condition exists. The element associated with the arm, hand or finger of a user to be detected may be a ring, bracelet, watch, watchband, skin patch, or other such item.

The proximity detector may be based on magnetism, capacitance, time-of-flight or any other mechanism capable of appropriate detection. The device operative to alert the user in response to the output signal generated by the proximity detector produces an audible, visual or tactile sensation, the latter including mild electrical shock. The sensor housing itself may produce the alert directly, or circuitry may be provided to produce a wireless signal to a separate unit operative to generate an audible, visual or tactile sensation. With appropriately miniaturized electronics, the entire sensor may be located solely on or in person's ear.

Further circuitry may be provided to measure the time during which the element is physically within the predetermined distance relative to the sensor so as to minimize false alarms. The system may also be equipped with a user-operable override preventing the alarm from being activated for a predetermined period of time to permit acceptable activities wherein the element has physically moved to within the predetermined distance relative to the sensor.

In the preferred embodiment, additional circuitry is provided enabling events to be examined and reviewed. Such circuitry would include a memory for storing information associated with alert events and an interface allowing the events to be examined and reviewed on a personal computer, for example. The provision of a real-time clock further enables date or time information to be stored in conjunction with an event.

For additional insight into the events, an input may be provided allowing a user to characterize an event at the time of occurrence. Such information would preferably also be stored in the memory for later examination and review through the interface. For instance, the user might be asked to push a button during/after an alarm event only if the event was triggered by a “problem,” and not to do so if it was “accidental” . . . or vice versa. On a multi-button model, there might be a green-yellow-red set of buttons and the user might be asked to rank the event as “not a problem,” “might be a problem” or “definitely a problem.” Other uses of buttons for user interaction will be able to be programmed into the device, which may be belt-worn for more convenient access.

### BRIEF DESCRIPTION OF THE DRAWINGS

FIG. 1 is a drawing of an individual equipped with apparatus according to this invention; and

FIG. 2 is a simplified block diagram of electronic circuitry applicable to the invention.

### DETAILED DESCRIPTION OF THE INVENTION

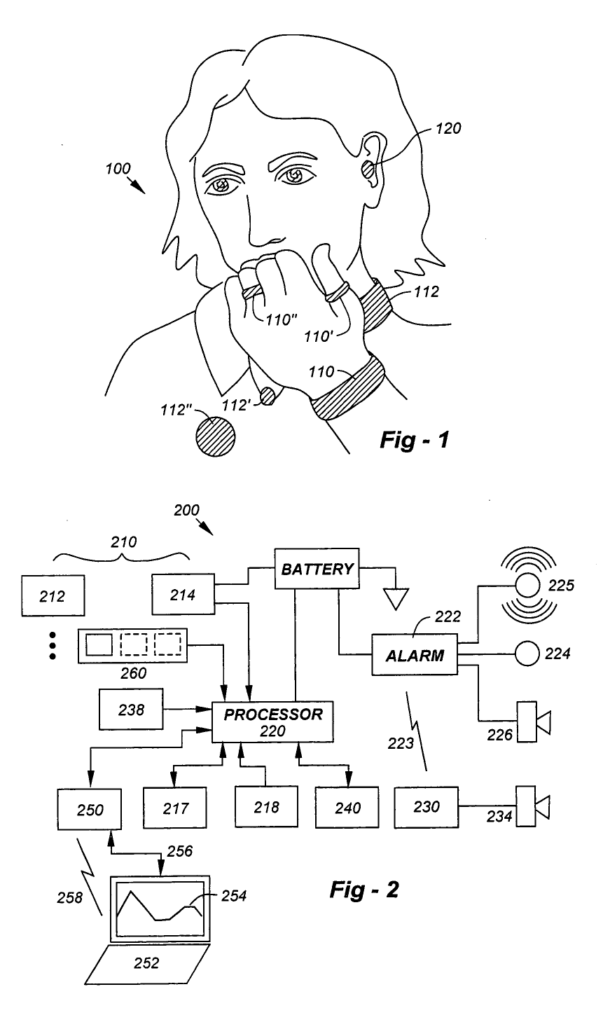

Now making reference to the drawings, FIG. 1 is an illustration of an individual depicted generally at 100 in conjunction with different physical placement embodiments according to the invention. In a preferred arrangement, a proximity detector including some form of sensor is used to detect an element and activate an alarm or otherwise make the individual aware that they are engaging in a behavior to be modified.

With respect to thumb-sucking and nail-biting in particular, a sensor is preferably located near the mouth of the individual, with an element to be detected being located on or near the hand. For example, as shown in FIG. 1, a sensor may be located on a neckband 112 or, alternatively, necklace 112′, broach 112″, or any other location operatively feasible. The element to be detected in this case may include a wristband 110 or, alternatively, thumb ring 110′, finger ring 110″, and so forth.

As discussed below, the invention is not limited in terms of the proximity detection scheme utilized. However, for practical reasons, it is desirable to have the larger and/or electrically active portion of the proximity detector being contained in the most discrete manner, while also enabling multiple elements to be detected, for example, in the case that an individual sucks both thumbs or chews on the nails of both hands. Thus, for example, the neckband 112, necklace 112′ or broach 112″ may be battery-operated and capable of detecting an electrically passive wristband or ring, thereby enabling multiple such elements to be used without replicating more expensive electronic circuitry. Nevertheless, the “active” portion of the circuit may also be located on the hand/limb to be detected, as the invention is not limited in this regard.

Although, in FIG. 1, the sensors and items to be detected are associated with the head and an extremity such as the hand, in the case of skin-scratching, it may not be the mouth area of the individual to be monitored, but rather, the back of the head or other portions of the scalp, the legs, and so forth. In such cases, while the element to detect would still be located on the hand(s), the sensor portion may be located at the back of the head on a neckband, in some form of head gear, on the legs, and so forth, depending upon the behavior to be controlled.

As discussed in more detail with respect to the block diagram of FIG. 2, the sensor portion includes some form of alarm or other type of signaling device to alert the individual 100 that they are engaging in an unwanted behavior. While the sensor portion itself (i.e., the neckband, necklace or broach) may include an audible alarm, or the like, it is also anticipated by the invention that a wireless link may be included to an alarm elsewhere on the body, such as a device 120 located in the ear. With appropriately miniaturized electronics, the entire sensor may be located solely on or in person's ear. Just as the invention is not limited in terms of the proximity detection scheme utilized, the invention is not limited in terms of the type of alarm used, and may include visible, audible, or tactile/vibrational transducers and mild shock generators, as appropriate.

Now making specific reference to the block diagram of FIG. 2, the proximity detector is shown generally at 210, involving a sensor aspect 214 in conjunction with one or more elements 212 to be detected. The signal from the sensor aspect 214 is received by a processor 220 or other type of electronic circuitry, driving an alarm circuit 222 which, as discussed above, may directly drive an audible alert 226, visual alert 224 or vibrational alert 225. As an option, or in conjunction with such mechanisms, a wireless signal 223 may be delivered to a remote alarm 230 also capable of driving an audible alert 234 or other type of visual/tactile alert (not shown). The wireless signal 223 may be of any form, including electromagnetic, optical or acoustic/ultrasonic of the type used by announcers, and the like which make use of passive ear-receiving devices.

The circuitry shown generally at 200 further includes a counter/delay block 217 to ensure against false alarms. This is important, since the hands of an individual are often brought up to the mouth or face for legitimate purposes, such as eating, coughing, toothbrushing, and so forth. Accordingly, the counter/delay circuitry 217 informs the processor 220 that short-lived detections utilizing the arrangement 210 may, in fact, be legitimate, such that longer-length or more consistent triggers should be used instead to activate the alarm circuit 222. Preferably the counter/delay circuitry 217 is adjustable, either by the user or a physician, as the case may be.

The circuitry shown generally at 200 further preferably includes some form of user control such as on/off, adjust/override circuit 218. Not only does this interface allow a user to turn the active portion on and off on a permanent basis, in the preferred embodiment, an override may be used should the person be engaging in a legitimate activity such as eating, coughing, toothbrushing, and so forth. In this particular instance, a button would be pressed, disabling the circuit from triggering for a predetermined (though adjustable) period of time, such as five minutes or thereabouts, after which the system would automatically become active and begin searching to detect undesirable behaviors.

In terms of sensors, as discussed above, the invention may utilize any form of proximity detection scheme, though in the preferred embodiment, a low-cost yet reliable system would be used, while enabling the element to be detected to be passive, enabling such element to assume the form of a ring, bracelet, or other discrete type of housing. Nevertheless, the invention may utilize capacitive sensing; electric-field sensing; various forms of magnetic sensing including inductive, Hall-effect, reed-switch and Eddy-current varieties; magneto-resistive approaches; optical/infrared; color/pattern recognition; ultrasonic; acoustic emission; radar; sonar; and approaches based upon conductive/resistance phenomena.

In the preferred embodiment, however, a magnetic or ultrasonic time-of-flight approach is used due to a desirable tradeoff between cost and acceptable range of detection. In terms of a magnetic solution, a magnetic-field sensor may be used. Such devices, available from companies including Philips, Honeywell, and others, are low in cost and sensitive in 1 to 3 dimensions, depending upon the component. A reed-switch sensor may alternatively be used, or a search-coil technique, which would detect the presence of various metals in addition to magnets and magnetizable materials. Various other magnetic/electromagnetic induction/detection methodologies are also applicable.

Ultrasonic proximity detectors use time-of-flight principles to measure distances measurable in inches, and are therefore also well-suited to the invention. An ultrasonic proximity detector operates by transmitting inaudible pulses, which are then measured and compared to the length of time that it takes the pulses to strike an object and return as an echo. The longer the time, the farther away the object. In this case, then, processor 220 would include appropriate circuitry to perform the counting and distance computation functions with the blocks 212 and 214 being responsible for the sending and detecting of the ultrasonic pulses. In all embodiments, a control is preferably provided to set a threshold related to distance to ensure accurate, repeatable results.

According to a more comprehensive embodiment of the invention, circuitry is provided to achieve further insight into alarm events and/or a user's behavioral patterns. Continuing the reference to FIG. 2, a real-time clock 238 communicates with processor 220, thereby keeping a record of triggering events in terms of date and/or time. Such information is stored by processor 220 in memory 240 for later retrieval. For example, utilizing interface 250, the event-related information stored in memory 240 may be downloaded to a computer 252 for review as information 254 on a screen thereof, either through a hard-wired connection 256 or a wireless connection 258. Any interface may be used, including an infrared link, Bluetooth technology, RF transmission, or USB or other interfaces. As set forth in the table below, an alarm and/or data logger may be used in a pager and/or PDA-type device worn on waist or in a pocket.

Advantageously, in addition to the date/time log stored in memory 240, a user event evaluation component 260 may be provided, allowing a user to provide information regarding a particular event. For example, utilizing a one-button model, a user could indicate whether a triggering event was in fact an actual “problem,” as opposed to an “accidental” event or false alarm. In addition, or as an option, a multi-button input may be provided, whereby depression of a red button might allow the user to rank the event as “definitely a problem,” depression of a yellow button as “might be a problem,” and the use of a green button might mean “not a problem at all.” The ability to log all incidents, preferably including date, time, duration and user response allows comprehensive analysis to be performed by the user and/or their therapist. This has significant advantages. First, user involvement has been shown to increase compliance. Secondly, the ability to review event history allows the user and the therapist to follow the progress of the user over a period of treatment, such as a day or week, etc., and address an appropriate course of action accordingly. The involvement of the therapist is further prompted by the addition of data review, allowing the device to more fully integrated into a particular treatment program.

The following table lists descriptions of various conditions along with solutions made possible by the invention, including the number of components in an applicable system. Following that a specific example associated with trichotillomania is given.

| Number of | | |
|---|---|---|
| Components | Condition | Description |
| 2 | Hair pulling, | One handed puller, biter or sucker. Trigger on hand/wrist, |
| | nail/finger biting or | Sensor/alarm/data logger on or near head (or vice versa). Sensor |
| | thumb sucking | could be in ear, on ear ring, pin under collar, necklace, bracelet, |
| | | watch, etc. |
| 2 | Nail tearing | Trigger on hand/wrist, Sensor/alarm/logger on other hand/wrist. |
| | | Sensor could be in bracelet, watch, etc. |
| 3 | Hair pulling, | Two handed puller, biter or sucker. Triggers on hand/wrist, |
| | nail/finger biting or | Sensor/alarm/logger on or near head (or vice versa). Sensor |
| | thumb sucking | could be in ear, on ear ring, pin under collar, necklace, bracelet, |
| | | watch, etc. |
| 3 | Hair pulling, | One handed puller, biter or sucker. Trigger on or near head, |
| | nail/finger biting or | sensor with RF communication on wrist/hand (or vice versa) and |
| | thumb sucking | alarm/data logger in pager/PDF type device worn on waist or in a |
| | | pocket. |
| 3 | Nail tearing | Trigger on one hand/wrist, sensor/communication device on the |
| | | other and alarm/data logger in pager/PDF type device worn on |
| | | waist or in a pocket. |
| 4 | Hair pulling, | Two handed puller, biter or sucker. Triggers on hand/wrist, |
| | nail/finger biting or | Sensor/communication device on or near head (or vice versa) and |
| | thumb sucking | alarm/data logger in pager/PDF type device worn on waist or in a |
| | | pocket. |

### EXAMPLE

### Trichotillomania

With respect to the specific application to trichotillomania the has two functions: 1) a vibrating/audio reminder function which is activated when persons with trichotillomania place their hands in a location associated with pulling for an amount of time typically associated with hair pulling, and 2) a hair pulling monitoring function.

As discussed above, many people with trichotillomania are unaware of a portion of their pulling episodes and commonly have limited insight into the extent of their pulling or near-pulling behavior. In the preferred embodiment, the AEMD will alert patients of near or actual pulling episodes with vibrating/audio pager-like device worn at the beltline. When the person with trichotillomania places his or her hand in a designated area associated with hair pulling for a pre-determined duration, the device will vibrate and/or sound, prompting the person to move his or her hands away from the actual or potential pulling site. The patient would then be encouraged to engage in a competing response exercise.

This AEMD would ideally be integrated within professionally guided course of habit reversal therapy. The device would be of benefit in the initial stages of habit reversal therapy as the clinician is attempting to establish a baseline level of hair-handling and pulling. This baseline level of pulling behavior would assist clinicians as they seek to identify high-risk times when pulling occurs and will also be helpful as point of comparison after initiation of habit reversal therapy. Baseline to treatment pulling levels would also assist clinicians as they make judgments about patient progress and the need to adjust the habit reversal strategies.

The monitoring feature would also be helpful as the clinician and patient attempt bring the severity of the hair pulling behavior into awareness. The vibrating/audio proximity alert function would assist in interrupting hair pulling precursor incidents or actual pulling behavior by bringing this behavior into awareness and possibly providing a mild punishment for engaging in these behaviors. The vibrating/audio alert is also likely to help maintain awareness of pulling behavior throughout the course of treatment since awareness commonly increases at the beginning of HRT but often declines as treatment continues (ref*). The vibrating/audio alert would be very valuable as a reminder to implement a competing response behavior. Competing responses are very effective in reducing hair pulling (ref*) but their use requires awareness of pulling and response precursor (*consider the term near pulling here . . . consistent) behavior.

There are several low-tech methods of enhancing awareness of hair pulling behavior. These methods include applying strong perfume to the wrists and wearing noisy or heavy jewelry on the hands or wrist (refs). One of the drawbacks associated with these strategies is the likelihood that the person with trichotillomania will gradually accommodate to these methods resulting in a gradual reduction in awareness enhancement (refs.) The vibrating/audio alert feature incorporated into the AEMD allows the individual to choose from two vibrating modes (pulse or continuous) or to select one of several auditory alerts. These options will likely help protect against accommodating to the alert feature.

The AEMD will record the date, time, and duration of nearly all pulling and near pulling episodes, with the buttons on the unit being programmed for trichotillomania-related activities. When individuals place their hand in proximity to a designated high-risk area (most likely the near the head) the AEMD will vibrate/sound and record the event. If the individual with trichotillomania has actually pulled hair, a button on the receiving unit will be depressed to indicate a pull. If a near-pulling incident occurred, a second button will be depressed. If a no near or actual pulling occurs, a third button will be depressed indicating that the individual inadvertently placed his or her hand in the habit prone area for benign reasons (e.g. adjusting one's glasses for an extended period). The button-pressing actions, like competing response behaviors, are incompatible with hair pulling and may also serve as a prompt to engage in prolonged competing response activities.

An important aspect of the invention is a device that can be worn without attracting negative attention from others. Persons with trichotillomania are often very self-conscious about their appearance and are concerned about drawing attention to themselves (ref*). Thus in this and other applications the AEMD will be inconspicuous. The preferred configuration for this application includes a regular-sized watch on one wrist, a ring or bracelet the other hand/wrist, a band of sensors to be placed in a shirt collar, and a pager-like vibrating/audio device to be worn at the belt-line or in a pocket. Although most persons with trichotillomania report that the majority of their pulling occurs in isolated situations when concealing the device may be less important, the apparatus could also be worn in public without attracting attention.

An issue related to the use of this device is whether it will encourage pulling on other areas of the body. Most people with trichotillomania pull their head hair or eyelashes and/or eyebrows. Drift between these areas will not be problematic if the sensors are located in the shirt collar. If the person with trichotillomania does begin to notice pulling in other areas, a second set of sensors could be placed near these areas as well. Although the device cannot deter a determined person with trichotillomania who engages in purposeful pulling with little interest in reducing pulling, it is versatile enough to respond to pulling that occurs in new areas away from the head.

The AEMD has substantial potential to improve outcomes with other habit problems including thumb sucking, skin picking, and nail biting. The monitoring function could be helpful for encouraging reduction of these behaviors in addition to providing necessary information for judging the benefits of treatment and planning for treatment modifications. These behaviors also often occur outside of the awareness of the individual and the AEMD could be helpful in enhancing awareness and reducing the frequency and duration of episodes (ref).

I claim:

1. Apparatus for discouraging trichotillomania and other unwanted behaviors, comprising:
a proximity detector operative to generate an alert in the event that a user's hand approaches an area of their body associated with an unwanted behavior;
a memory for storing information associated with the event;
an input allowing a user to characterize the event; and
an interface enabling at least the information to be recalled for later review.

2. The apparatus of claim 1, further including a real-time clock enabling date or time information to be stored in conjunction with an event.

3. The apparatus of claim 1, further including:
an input allowing a user to evaluate an event at the time of occurrence; and
wherein the evaluation is stored in the memory for later examination and review through the interface.

4. The apparatus of claim 1, further including:
an input allowing a user to characterize an event as a problem or an accidental alert; and
wherein the user's characterization is stored in the memory for later examination and review through the interface.

5. The apparatus of claim 1, further including:
an input allowing a user to grade an event in terms of problem level;
wherein the user's grading is stored in the memory for later examination and review through the interface.

6. The apparatus of claim 1, wherein the interface includes an interconnection to a computer enabling the stored information to be displayed.

7. The apparatus of claim 1, wherein the proximity detector comprises:
a body-worn housing including a proximity sensor; and
an element worn on the arm, hand or finger of a user which is detectable by the proximity sensor.

8. The apparatus of claim 8, wherein the element worn on the arm, hand or finger is a ring.

9. The apparatus of claim 8, wherein the element worn on the arm, hand or finger is a bracelet.

10. The apparatus of claim 8 wherein the element worn on the arm, hand or finger is a watch or watchband.

11. The apparatus of claim 8, wherein the housing is in the form of a neckband, necklace or broach.
